(19) United States
(12) Patent Application Publication
(10) Pub. No.: US 2013/0269456 A1
(43) Pub. Date: Oct. 17, 2013

(54) Stackable Multi-Unit Power Take-Off Assembly For ATV

(71) Applicant: Kirk Jones, Vista, CA (US)

(72) Inventor: Kirk Jones, Vista, CA (US)

(21) Appl. No.: 13/860,841

(22) Filed: Apr. 11, 2013

Related U.S. Application Data
(60) Provisional application No. 61/623,009, filed on Apr. 11, 2012.

(51) Int. Cl. B60K 17/28

(52) U.S. Cl. CPC B60K 17/28
USPC 74/15.2

(57) ABSTRACT

A modular, multi-unit power take-off assembly for an all-terrain vehicle (ATV) having an internal combustion engine with an engine casing and an exposed engine shaft. The multi-unit power take-off assembly is variably formed from one or more power take-off units, or modules, that are stackable in various desired arrangements. The first power take-off assembly in the stack may be a generator assembly for driving electric implements. The generator assembly mechanically connects to the engine casing and has a rotor with an ATV-side drive connector that mates with the engine shaft and a carry-forward drive connector that mates with a next-in-sequence power take-off unit that, for example, consists of another generator assembly or a hydraulic pump for driving hydraulic implements, or both.

### RELATED APPLICATIONS

This application claims the benefit of U.S. Provisional Patent Application Ser. No. 61/623,009, filed Apr. 11, 2012.

### BACKGROUND OF THE INVENTION

1. Field of the Invention

The invention relates to all terrain vehicles (ATVs) or the like and, more specifically, to a stackable generator assembly for use with an ATV.

2. Description of the Prior Art

An all terrain vehicle (ATV) is a small open single-rider vehicle having four wheels and generally designed for off-road use on various types of terrain or rough ground. The American National Standards Institute (ANSI) defines an ATV as a vehicle that travels on low-pressure tires, with a seat that is straddled by the operator, along with motorcycle-like handlebars for steering control. ATVs usually do not have windshields.

Other vehicles of similar size, power, and all-terrain capability have different names. For example, a UTV (utility task vehicle), sometimes called a “side-by-side,” is a slightly larger four-wheel drive vehicle that usually has conventional steering wheel and provides seating for 2 or 4 people in a side-by-side arrangement. UTVs sometimes have windshields. UTVs often have small truck beds and, as a result, are popular among golf course maintenance personnel, parks and recreation departments, and any other users who need to travel over uneven terrain with people and materials.

ATVs and UTVs are traditionally sold by well-known manufacturers such as Honda, Kawasaki, Arctic Cat, Yamaha, Can-Am, Suzuki, and Polaris. For the sake of simplicity, this application will refer to vehicles in this general class as “ATVs.”

An ATV is usually powered by an internal combustion engine that runs on gasoline or other suitable fuel (e.g. propane, diesel fuel, etc.) The ATV's engine is usually coupled to a pair of rear-drive wheels via the engine's drive shaft and an intermediate transmission. Some ATVs even include four wheel drive power train.

ATV's are often used for recreational purposes, but ATV manufacturer's have also produced models that are well-suited for use as general purpose work vehicles or utility vehicles (e.g. on a farm or other large property, for military purposes, etc.).

Due to the ever increasing demand to use ATVs as work vehicles, various implements have been designed to convert ATVs into more useful vehicles, such as lawn mowers, log splitters, electric generators, etc. However, these attachments normally came with significant drawbacks in that duplicate engines were needed to run the separate implements that may or may not be pulled by the ATV, which is very costly and needlessly weighs down the ATV. Conventional implements are custom installed and are cumbersome and time consuming to utilize in that they are required to be bolted onto the ATV engine and have to be completely unbolted and disassembled to operate the ATV in a normal function when not using the implement.

U.S. Pat. Nos. 7,284,625 and 7,600,594, hereby incorporated by reference, disclose a unique hydraulic power take-off (PTO) system. The two patents more specifically disclose a quick connect/disconnect assembly for a power transfer unit designed for use with an ATV. The power transfer unit detachably connects to an output shaft associated with the rotation of the ATV's engine (usually the engine's drive shaft) and then powers an implement connected to, carried by, or located near the ATV.

The preferred power transfer unit is a hydraulic pump that forces fluid through a hydraulic circuit and drives a hydraulic motor associated with the implement. The exemplary implements that could be driven with the hydraulic power transfer unit included a lawn mower, a water sprayer, a snow blower, an air compressor, a water pump, a post-hole digger, an electric generator, a wood chipper, and a log splitter.

In the typical ATV, the engine includes an engine case and a drive shaft or other engine shaft that extends from the engine case. Typically, the engine's drive shaft is accessible beneath the drive shaft cover or starter cover that is historically associated with a so-called “Recoil Starter.” The drive shaft cover may include a pull handle to permit the operator to hand start the engine in the event that the electrically-driven starter is inoperable, but today, most covers do not.

In one commercial embodiment made according to the '625 and '594 patents, designed for retrofitting a hydraulic power take-off unit to a BRUTE FORCE® model ATV manufactured by KAWASAKI®, the starter cover is removed and a drive plate that carries a female coupler is retrofitted to the drive shaft. Then, the starter cover is replaced with a quick connect case that provides suitable quick connect features along its periphery and has a central aperture that exposes an outward face of the female coupler. Using a suitable quick connect/disconnect mechanism that mates with the features on the case, the hydraulic pump is connected to the quick connect case and, inside of the case, the hydraulic pump's input shaft and associated male coupler are mated with the female coupler.

The quick connect assembly and hydraulic power transfer unit disclosed in the '625 and '594 patents advantageously allows an ATV owner to power various implements by using the ATV's own engine—without requiring a duplicate engine on the implement. However, the need not then being appreciated, no consideration was given to connecting an electric generator to the ATV engine and using it as a power transfer unit per se (i.e. as opposed to having a remotely-positioned generator driven as a hydraulic implement), to the attachment of more than one power transfer unit and, in particular, to the stackable attachment of multiple power transfer modules (e.g. one or more supplemental generators, alone or in combination with a power transfer unit).

Accordingly, a need has been developed in the art to provide a system or sub-assembly of stackable power transfer units for use with an ATV.

### BRIEF SUMMARY OF THE INVENTION

It is a primary object of this invention to provide a multi-unit power take-off assembly for an all-terrain vehicle (ATV) formed from modular, interconnected power take-off units.

The preferred embodiment of the invention is a multi-unit power take-off assembly adapted for an all-terrain vehicle (ATV) having an engine with an engine case and an engine shaft that extends from the engine case, the multi-unit power take-off assembly comprising: a first power take-off unit comprising a first housing that is fixedly mounted to the engine case of the ATV, an ATV-side drive connector that connects to the engine shaft so that the first power take-off unit is rotationally-driven by the engine, and a carry-forward drive connector that is exposed to an outer side of the first power take-off unit; and a second power take-off unit comprising a second housing that releasably connects to the first housing of the first power take-off unit in stacked succession, and an ATV-side drive connector that connects to the first power take-off unit's carry-forward drive connector so that the second power take-off unit is also rotationally-driven by the engine. In the preferred embodiment, the first power take-off units is a generator assembly for powering electric implements and the second power take-off unit comprises a hydraulic pump for powering hydraulic implements.

Two or more generator assemblies may be stacked and electrically connected in parallel for providing increased electrical power to the electrically driven implements.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1 is a perspective view of a typical prior art ATV.

FIG. 2 is a close-up perspective view of an ATV that has been outfitted with a hydraulic power take-off unit of known configuration;

FIG. 3 shows an enhanced ATV 140 that features a stacked or multi-unit power take-off assembly 100 having a self-contained generator assembly 110 and a hydraulic power take-off unit 130, according to a first preferred embodiment of the invention;

FIG. 4 is an exploded view of the presently preferred, self-contained generator assembly 110 of FIG. 3;

FIG. 5 is an assembled view of the presently preferred generator assembly 110, showing its carry-forward drive connector 122;

FIG. 6 is an exploded perspective view of the first preferred multi-unit power take-off assembly 100 that, as also shown in FIG. 3, comprised of a hydraulic pump 130 stacked on a generator assembly 110;

FIG. 7 is an exploded perspective view of a first alternative multi-unit power take-off assembly 200 comprised of two generators assembly 110; and

FIG. 8 is an exploded perspective view of a second alternative multi-unit power take-off assembly 300 comprised of a hydraulic pump 130 stacked on a first generator assembly 110 which, in turn, is stacked on a second generator assembly 110.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

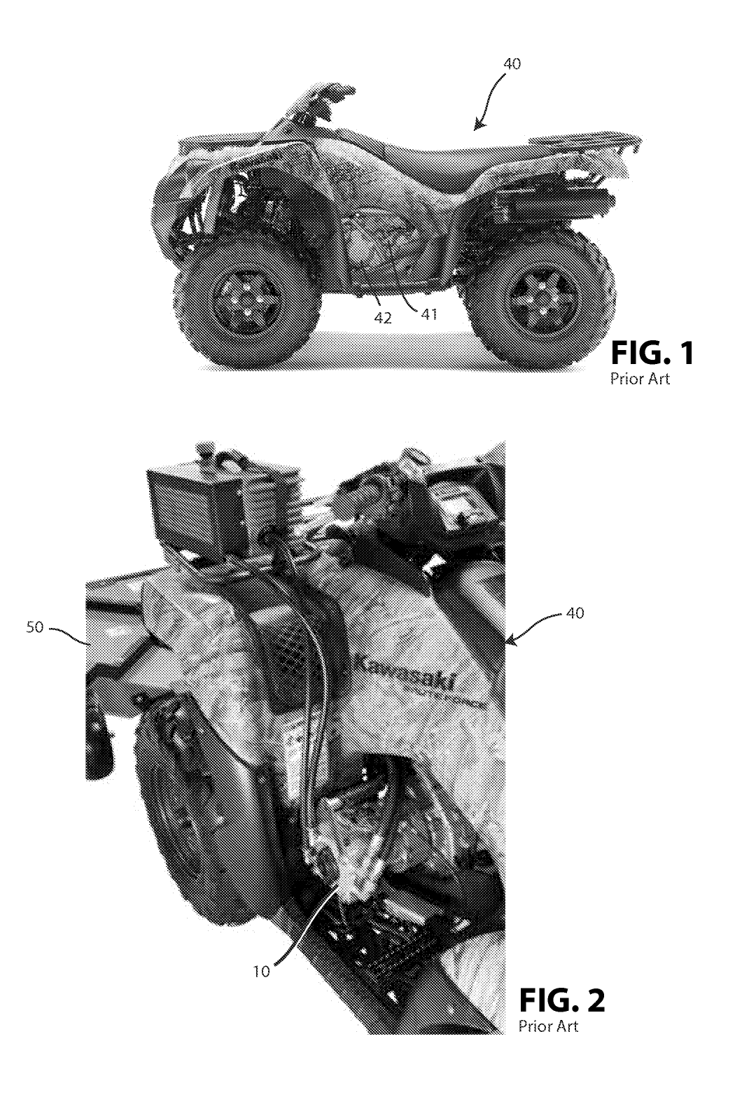

FIG. 1 shows a typical all-terrain vehicle (ATV 40) that can be manufactured or retrofitted to include a stackable generator assembly according to various possible embodiments of the present invention. The ATV 40 includes an internal combustion engine 41 with an ATV engine shaft (not shown) that is accessible behind a cover 42.

FIG. 2 shows the ATV 40 of FIG. 1 after a hydraulic power take-off (PTO) system 10 has been retrofitted to the ATV engine's drive shaft (not shown) in place of the original cover 42. The hydraulic hoses from the hydraulic PTO system 10 transfer power from the ATV's engine to an implement The hydraulic PTO system 10 comprises a hydraulic pump that receives rotational energy from the engine shaft and then discharges hydraulic fluid under pressure, through a hydraulic circuit formed by suitable hoses, to power a hydraulic motor located on an associated implement 50 (e.g. a rough cut mower attached to the front of the ATV).

The prior art hydraulic PTO system 10 of FIG. 2 advantageously allows an ATV owner to power various implements 41 by using the ATV's own engine—without requiring a duplicate engine on the implement. However, the prior art system only allowed the owner the option of installing a single hydraulic PTO system. No provision was made for attaching a supplemental generator to the engine's drive shaft, and no provision was made for the stackable arrangement of one or more supplemental generators, alone or in combination with a hydraulic power transfer unit.

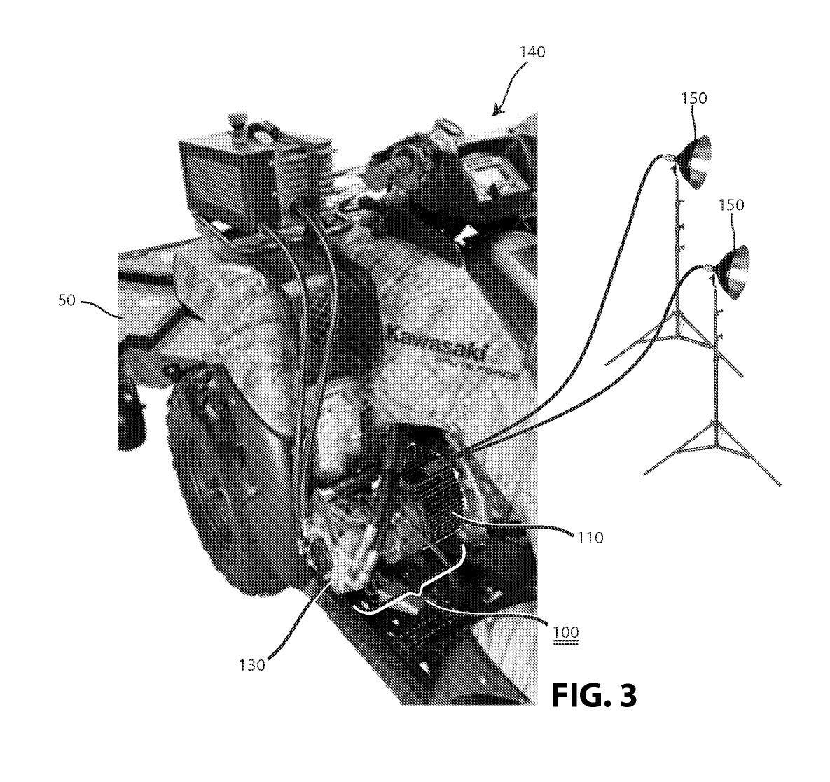

FIG. 3 shows an enhanced ATV 140 according to a first preferred embodiment of the invention. As shown, the enhanced ATV 140 features a multi-unit power take-off assembly 100 according to a first preferred embodiment of the invention. In this particular embodiment, a multi-unit power take-off assembly 100 comprises a generator assembly 110 that is coupled to the ATV engine's drive shaft and a hydraulic PTO pump 130 that is coupled to the generator assembly 110—in a stacked arrangement. The phrase generator assembly 110 refers to any electromechanical device (i.e. a generator, an alternator, etc.) that is capable of producing electric power when rotationally-driven.

As a result of the stacked multi-unit power take-off assembly 100, the enhanced ATV 140 can drive a hydraulic implement (e.g. 50) with the hydraulic PTO pump 130 while also driving one or more electrical implements (e.g. flood lamps 150 used for lighting the work area) with the generator assembly 110.

As suggested by the presently preferred embodiment of FIG. 3, a quick connect generator for an ATV provides many beneficial features, including:

1) Self contained quick connect/disconnect generator assembly 110 (The present version is targeted at 1.5-2.0 KW) Typical ATV generator is 200-300 watt.

2) High power density allows compact size which can easily be fitted to the side case of the ATV engine

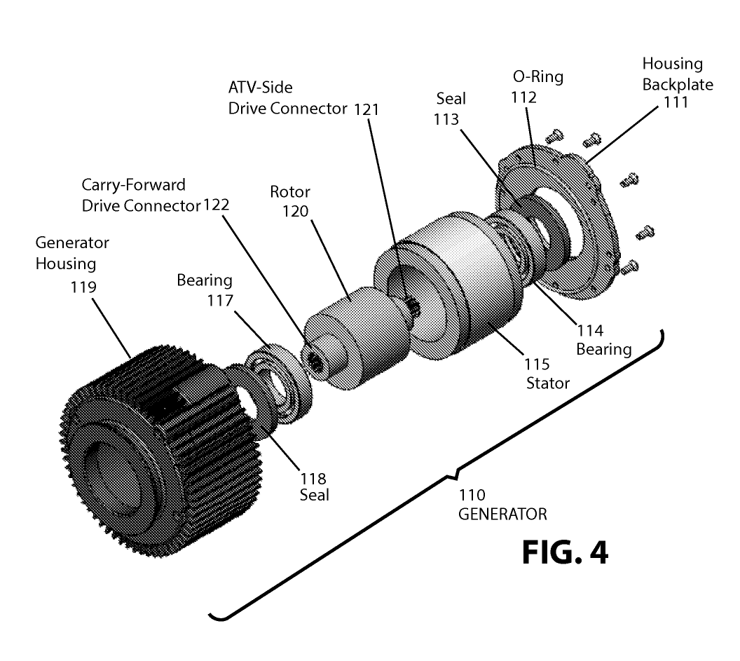

3) “Plug and play” rotor 120 (see FIGS. 4 to 8) with quick connect/disconnect feature will allow multiple generators 110 to be stacked and run in parallel for higher power requirements or, if multiple vehicles have a single generator and can be located in close proximity to each other, the generators 110 can be electrically linked via cable for additional power requirements.

4) “Plug and Play” rotor 120 with quick connect/disconnect feature will allow hydraulic pumps or non-hydraulic tools such as a high pressure washer pump to plug into the generator assembly 110 allowing for simultaneous operation of the electrical generator assembly 110 and hydraulic work tools or other mechanical devices. This ability would be extremely important for remote night time search and rescue operations. An example would be a requirement for extraction at a remote plane wreck site of injured passengers at night. The ATV 140 could not only supply area lighting 150 but also run “Jaws of Life” hydraulic rescue tools to cut the crumpled plane entrapping the passengers.

5) This new high power density generator design can also be designed to replace the vehicles standard low power density generator which is internal to the side case of the engine, thus saving weight and space which is very critical in many military special forces operations.

6) This high power density generator will also greatly reduce the need to carry multiple redundant back up batteries by military forces on multi-day operations since it will be capable of charging a vast array of batteries.

7) The system is also ideal to be able to run temporary remote communications equipment

Still with FIG. 3, one can see that the generator assembly 110 uniquely allows the user to have electrical power in the vicinity of the ATV 140 and, at the same time and when desired, allows the user to operate a hydraulically driven implement or tools via the hydraulic pump 130.

The exact manner of attaching the generator assembly 110 to the ATV 140 is not critical to the present invention. The generator assembly 110 can be connected to the ATV 140 with a suitable quick connect/disconnect mechanism, or it can be more permanently attached. Likewise, the exact manner of attaching the next-in-sequence mechanism (e.g. hydraulic pump 130) to the generator assembly 110 is not critical to the present invention. The successive devices can be attached with a suitable quick connect/disconnect mechanism, with threaded fasteners, clamping mechanisms, etc. In fact, the generator could be embedded in the engine case from the factory, and provision can still be made (e.g. by way of a female spline 122, discussed below) for attaching another, next-in-sequence, power take-off mechanism to the generator assembly 110.

FIG. 4 is an exploded view of the presently preferred, self-contained generator assembly 110. As shown, the preferred generator assembly 110 includes a housing backplate 11 that provide a suitable geometry for attachment to the ATV engine case. A generator housing 119 (with cooling fins, not numbered) mounts to the backplate 11 and encloses the internal components which include an o-ring 112, a seal 113, a bearing 114, a stator 115, a rotor 120, a bearing 117, and a seal 118.

The rotor 120, of significance to the presently preferred embodiment, includes an ATV-side connector 121 for mating with the ATV engine's drive shaft (or intermediate component) and a carry-forward connector 122 for mating with a next-in-sequence hydraulic pump 130 (as shown in FIG. 3), or another generator assembly 110, or some other driven mechanism. In the preferred embodiment, the ATV-side connector 121 is a male spline connector or splined drive shaft and the carry-forward connector 122 is a female spline connector or splined drive socket.

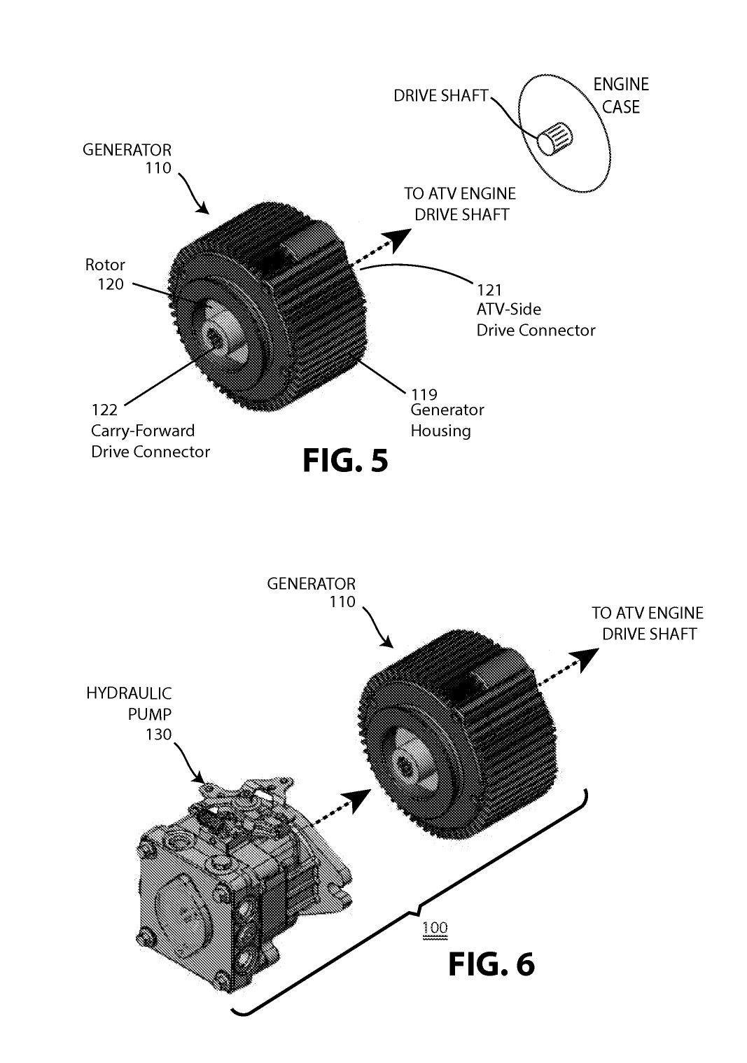

FIG. 5 is an assembled view of the generator assembly 110. As shown, the rotor's carry-forward drive connector 122 is centrally exposed in a front face of the generator housing 119 in order to transfer ATV engine power to a next-in-sequence hydraulic pump 130 (as shown in FIG. 3), or to another generator assembly 110, or if desired, to both.

There are many different possible combinations of power transfer units, whether in the form of a generator assembly 110, a hydraulic pump 130, or some other mechanism. The following embodiments are illustrative examples.

FIG. 6 is an exploded perspective view of a multi-unit power take-off assembly 100 comprised of a hydraulic pump 130 stacked on a generator assembly 110, as shown in FIG. 3.

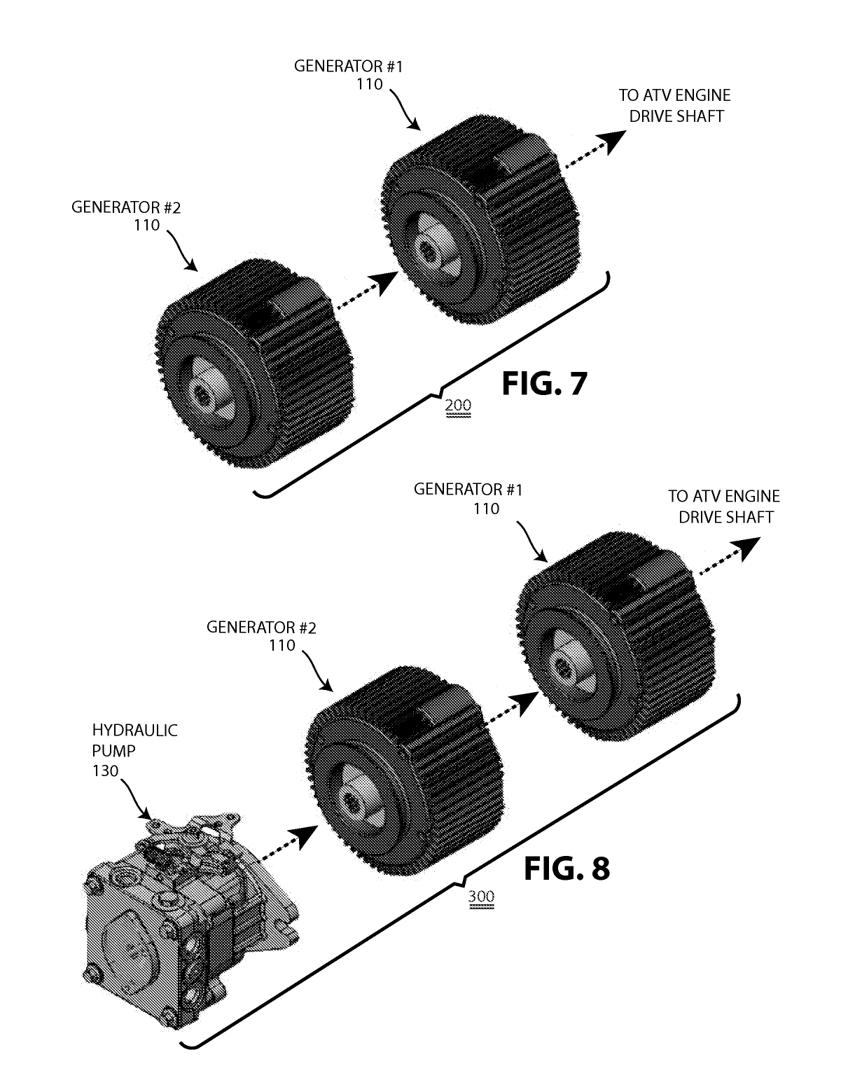

FIG. 7 is an exploded perspective view of a first alternative multi-unit power take-off assembly 200 comprised of two generators 110, one stacked on the other. The multi-unit power take-off assembly 200 based on two generators beneficially allows for the satisfaction operation of devices having high power requirements.

FIG. 8 is an exploded perspective view of a second alternative multi-unit power take-off assembly 300 comprised of a hydraulic pump 130 stacked on a first generator assembly 110 which is stacked on a second generator assembly 110. The second alternative multi-unit power take-off assembly 300 provides for the same benefits of a multi-generator configuration (FIG. 7), with the added benefit of permitting the user to simultaneously operate hydraulically driven tools or implements.

Many alterations and modifications may be made by those having ordinary skill in the art without departing from the spirit and scope of the invention. For example, other types of modules may be employed, even more modules may be stacked, and many other permutations are possible beyond the exemplary configurations shown in the illustrations.

As another example, although in the preferred embodiment, the generator housing 119 is cylindrical, the housing 119 can be any shape that can be connected or retrofitted onto an existing ATV. The housing 119 can be made of metal, or from a suitable injection molded polymer. The power transfer unit 130 can be any kind of power transfer unit, including but not limited to a hydraulic pump or a pulley system.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

We claim:

1. A multi-unit power take-off assembly adapted for an all-terrain vehicle (ATV) having an engine with an engine case and an engine shaft that extends from the engine case, the multi-unit power take-off assembly comprising:
a first power take-off unit comprising a first housing that is fixedly mounted to the engine case of the ATV, an ATV-side drive connector that connects to the engine shaft so that the first power take-off unit is rotationally-driven by the engine, and a carry-forward drive connector that is exposed to an outer side of the first power take-off unit; and
a second power take-off unit comprising a second housing that releasably connects to the first housing of the first power take-off unit in stacked succession, and an ATV-side drive connector that connects to the first power take-off unit's carry-forward drive connector so that the second power take-off unit is also rotationally-driven by the engine.

2. The multi-unit power take-off assembly wherein at least one of the power take-off units is a generator assembly for powering electric implements.

3. The multi-unit power take-off assembly wherein at least one of the power take-off units comprises a hydraulic pump for powering hydraulic implements.

4. A multi-unit power take-off assembly adapted for an all-terrain vehicle (ATV) having an engine with an engine case and an engine shaft that extends from the engine case, the multi-unit power take-off assembly comprising:
a first power take-off unit comprising a first generator assembly having a first generator housing that is fixedly mounted to the ATV, a first rotor, and a first stator, the first rotor including an ATV-side drive connector that connects to the engine shaft so that the first rotor is rotationally-driven by the engine to generate electric power, the first generator assembly further comprising a carry-forward drive connector that is exposed to an outer side of the first generator housing and is also rotationally-driven by the engine when the ATV-side connector is rotationally-driven by the engine; and
a second power take-off unit comprising a housing that releasably connects to the first generator housing in stacked succession, and an ATV-side drive connector that connects to the first power take-off unit's carry-forward drive connector so that the second power take-off unit is also rotationally-driven by the engine.

5. The multi-unit power take-off assembly of claim 4 wherein the second power take-off unit comprises a hydraulic pump.

6. The multi-unit power take-off assembly of claim 4 wherein the second power take-off unit comprises a second generator assembly.

7. The multi-unit power take-off assembly of claim 6 wherein the second generator assembly has a second generator housing that mechanically connects to the first generator housing in stacked succession, a second rotor, and a second stator, the second rotor including an ATV-side drive connector that connects to the first generator assembly's carry-forward drive connector so that the second rotor is rotationally-driven by the engine, through the first generator assembly, to generate more electric power, the second generator assembly further comprising a second carry-forward drive connector that is exposed to an outer side of the second generator housing and is also rotationally-driven by the engine, through the first generator assembly, when the first generator assembly's ATV-side connector is rotationally-driven by the engine.

8. The multi-unit power take-off assembly of claim 7 wherein the electrical outputs of the first and second generator assemblies are connected in parallel to satisfy higher power requirements.

9. The multi-unit power take-off assembly of claim 7 further comprising a third power take-off unit.

10. The multi-unit power take-off assembly of claim 9 wherein the third power take-off unit comprises a hydraulic pump.

11. The multi-unit power take-off assembly of claim 4 wherein the first generator housing's ATV-side drive connector comprises a male spline connector and wherein the carry-forward drive connector comprise a female spline connector.

12. A multi-unit power take-off assembly adapted for an all-terrain vehicle (ATV) having an engine with an engine case and an engine shaft that extends from the engine case, the multi-unit power take-off assembly comprising:
a first power take-off unit comprising a first generator assembly having a first generator housing that is fixedly mounted to the ATV, a first rotor, and a first stator, the first rotor including an ATV-side drive connector that connects to the engine shaft so that the first rotor is rotationally-driven by the engine to generate electric power, the first generator assembly further comprising a carry-forward drive connector that is exposed to an outer side of the first generator housing and is also rotationally-driven by the engine when the ATV-side connector is rotationally-driven by the engine;
a second power take-off unit comprising a second generator housing that mechanically connects to the first generator housing in stacked succession, a second rotor, and a second stator, the second rotor including an ATV-side drive connector that connects to the first generator assembly's carry-forward drive connector so that the second rotor is rotationally-driven by the engine, through the first generator assembly, to generate more electric power, the second generator assembly further comprising a second carry-forward drive connector that is exposed to an outer side of the second generator housing and is also rotationally-driven by the engine, through the first generator assembly, when the first generator assembly's ATV-side connector is rotationally-driven by the engine; and
a third power take-off unit comprising a housing that mechanically connects to the second generator housing in stacked succession, and an ATV-side drive connector that connects to the second generator assembly's carry-forward drive connector so that the third power take-off unit is also rotationally-driven by the engine.

13. The multi-unit power take-off assembly of claim 12 wherein the third power take-off unit comprises a hydraulic pump.

14. The multi-unit power take-off assembly of claim 12 wherein the third power take-off unit comprises a third generator assembly.
